(19) United States
(12) Patent Application Publication
(10) Pub. No.: US 2022/0072461 A1
(43) Pub. Date: Mar. 10, 2022

(54) SCRUBBER BOX FOR PAINT BOOTH

(71) Applicant: GM GLOBAL TECHNOLOGY OPERATIONS LLC, Detroit, MI (US)

(72) Inventors: Leticia Z. Klaiber, Sao Paulo (BR); Carlos N. Mendes, Sao Paulo (BR); Luciano P. Oliveira, Sao Paulo (BR); Thiago Ferronato, Sao Caetano do Sul (BR); Mauricio S. Nascimento, Maua (BR); Railson Borba da Rosa, Sao Caetano do Sul (BR); Andre Eboli, Sao Paulo (BR)

(73) Assignee: GM GLOBAL TECHNOLOGY OPERATIONS LLC, Detroit, MI (US)

(21) Appl. No.: 17/017,180

(22) Filed: Sep. 10, 2020

(51) Int. Cl. B01D 46/00; B01D 46/02; B01D 46/12; B01D 46/48; B01D 46/42; B05B 16/60

(52) U.S. Cl. CPC B01D 46/0008; B01D 46/023; B01D 46/12; B01D 46/0023; B01D 2267/30; B01D 46/4254; B05B 16/60; B01D 2265/04; B01D 46/48

(57) ABSTRACT

In various embodiments, a scrubber box for a paint booth is provided, along with a method of preparing for operation of the scrubber box. In an exemplary embodiment, a scrubber box for a paint booth is provided that includes a housing; a plurality of filter frames disposed within the housing; and a plurality of first stage filters disposed within the housing, the plurality of first stage filters each having the same size and shape as one another.

### INTRODUCTION

The technical field generally relates to paint booths and, more specifically, to scrubber boxes for paint booths.

Paint booths are often used to paint vehicles along with any number of other different types of items. Often paint booths have a scrubber system. Certain paint booths utilize a wet scrubber system, while certain other paint booths utilize a dry scrubber system. In general, a dry scrubber system recirculates spray booth air by directing it into scrubber chambers where a filter captures wet paint particles. However, in certain embodiments, existing scrubber systems may not always be optimal in certain situations.

Accordingly, it is desirable to provide improved scrubber systems for vehicles. Furthermore, other desirable features and characteristics of the present invention will become apparent from the subsequent detailed description of the invention and the appended claims, taken in conjunction with the accompanying drawings and this background of the invention.

### SUMMARY

In accordance with an exemplary embodiment, a scrubber box for a paint booth is provided, the scrubber box including: a housing; a plurality of filter frames disposed within the housing; and a plurality of first stage filters disposed within the housing, the plurality of first stage filters each having the same size and shape as one another.

Also in accordance with an exemplary embodiment, the housing and the plurality of filter frames are each made of metal.

Also in accordance with an exemplary embodiment, the housing and the plurality of filter frames are each reusable.

Also in accordance with an exemplary embodiment, the housing and the plurality of filter frames are welded together.

Also in accordance with an exemplary embodiment, the housing and the plurality of filter frames are each made of steel.

Also in accordance with an exemplary embodiment, the housing and the plurality of filter frames are each made of stainless steel.

Also in accordance with an exemplary embodiment, the housing and the plurality of filter frames are each made of galvanized steel.

Also in accordance with an exemplary embodiment, the plurality of filter frames includes: a first filter frame forming one or more first slots for an upper first stage filter; and a second filter frame disposed below the first filter frame and forming one or more second slots for a lower first stage filter.

Also in accordance with an exemplary embodiment, each of the one or more first slots have common filter dimensions; and each of the one or more second slots also have the common filter dimensions identical to those of the one or more first slots.

Also in accordance with an exemplary embodiment, the scrubber box further includes one or more second stage filters; wherein the scrubber box is configured to direct airflow: in a first direction, from top to bottom, from an air inlet through the upper row of first stage filters and the lower row of first stage filters; and subsequently, in a second direction, from front to rear, through the one or more second stage filters.

Also in accordance with an exemplary embodiment, the one or more second stage filters includes a mat filter.

Also in accordance with an exemplary embodiment, the scrubber box further includes an inclined top surface on an upper portion of the body, wherein the top surface and the housing form an inlet into the scrubber box.

Also in accordance with an exemplary embodiment, the scrubber box further includes a door with one or more openings for one or more inspection windows for the scrubber box.

Also in accordance with an exemplary embodiment, the scrubber box further includes a drawer configured to collect waste for the scrubber box.

Also in accordance with an exemplary embodiment, the scrubber box further includes one or more bottom supports configured for movement of the scrubber box in conjunction with a forklift.

In another exemplary embodiment, a method of preparing for operation of a scrubber box for a paint booth is disclosed the includes: locating a second stage filter via an opened back door frame of the scrubber box; closing the back door frame; installing a plurality of first stage filters through an opened front door of the scrubber box; and closing the front door.

Also in an exemplary embodiment, the method further include locking the back door frame and the front door.

Also in an exemplary embodiment, the method further includes moving the scrubber box into operating position, via a forklift and one or more bottom supports of the scrubber box.

In another exemplary embodiment, a metallic scrubber box for a paint booth is provided, the metallic scrubber box including: (i) a metallic housing; (ii) a plurality of metallic filter frames disposed within the housing, the plurality of metallic filter frames including: (a) a first filter frame forming one or more first slots, each of the one or more first slots having common filter dimensions; and (b) a second filter frame disposed below the first filter frame and forming one or more second slots, each of the one or more second slots also having the common filter dimensions identical to those of the one or more first slots; (iii) a plurality of first stage filters disposed within the first filter and the second filter, the plurality of first stage filters each having the same size and shape as one another; and (iv) one or more second stage filters disposed behind the second filter frame.

Also in an exemplary embodiment, the metallic housing and the plurality of metallic filter frames are all welded together.

### DESCRIPTION OF THE DRAWINGS

The present disclosure will hereinafter be described in conjunction with the following drawing figures, wherein like numerals denote like elements, and wherein:

FIG. 1 is front perspective view of a scrubber box for a paint booth, in accordance with an exemplary embodiment;

FIG. 2 is rear perspective view of the scrubber box of FIG. 1, in accordance with an exemplary embodiment;

FIG. 3 is a close-up view of a top portion of the scrubber box of FIG. 1, in accordance with an exemplary embodiment;

FIG. 4 depicts an interior of the scrubber box of FIG. 1, illustrating filters thereof, in accordance with an exemplary embodiment;

FIG. 5 depicts an airflow of the scrubber box of FIG. 1, in accordance with an exemplary embodiment;

FIG. 6 is a flowchart of a process for preparation for operation of the scrubber box of FIG. 1, in accordance with an exemplary embodiment;

FIG. 7 provides a close-up view of a front door of the scrubber box of FIG. 1, including a handle and a locking pin apparatus thereof, in accordance with an exemplary embodiment; and

FIGS. 8A, 8B, and 8C (also collectively referred to as FIG. 8) provides a close-up view of a drawer of the scrubber box of FIG. 1, including a handle thereof, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

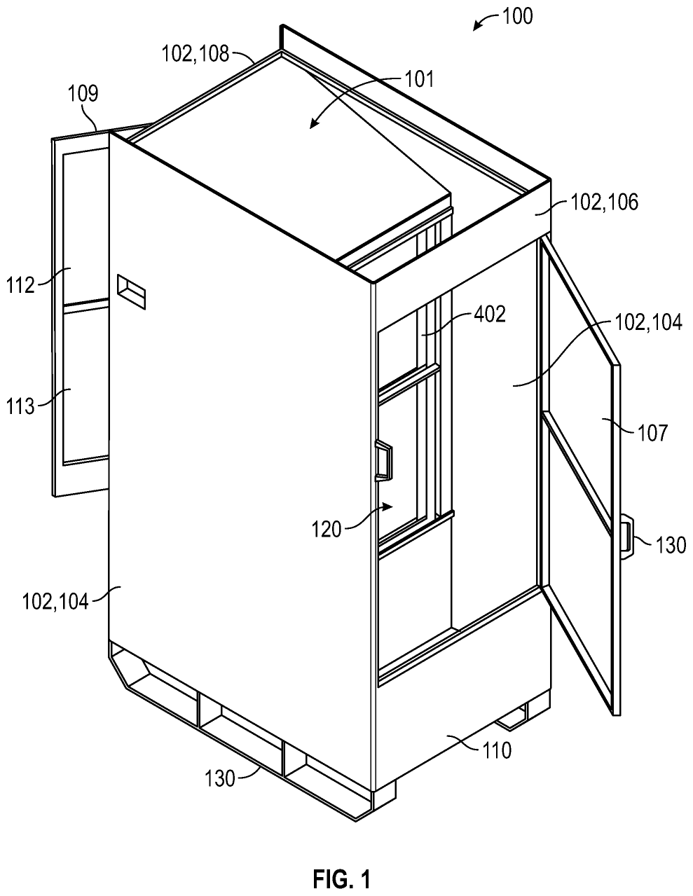

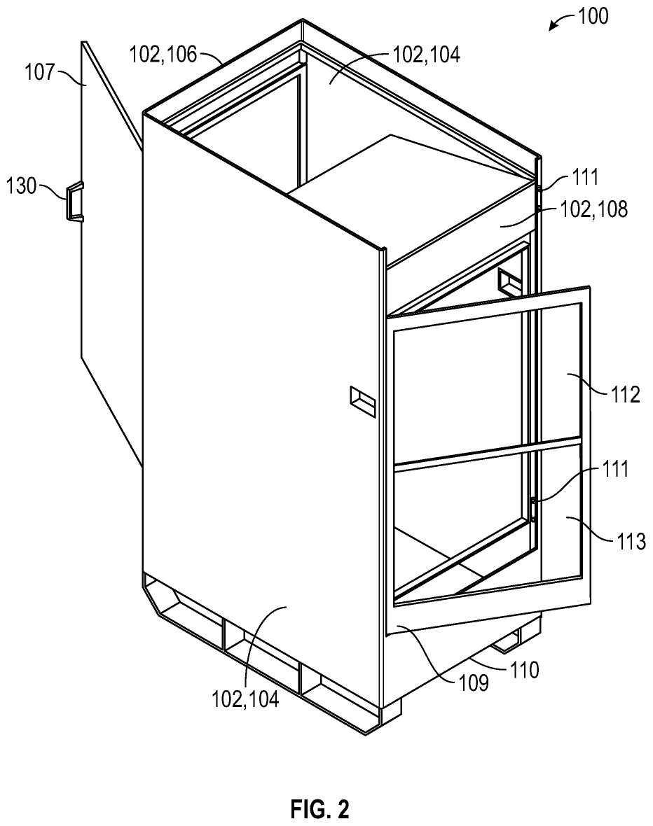

FIGS. 1 and 2 depict perspective views of a scrubber box 100 for a paint booth, in accordance with an exemplary embodiment. Specifically, FIG. 1 depicts a front perspective view of the scrubber box 100, and FIG. 2 depicts a rear perspective view of the scrubber box 100.

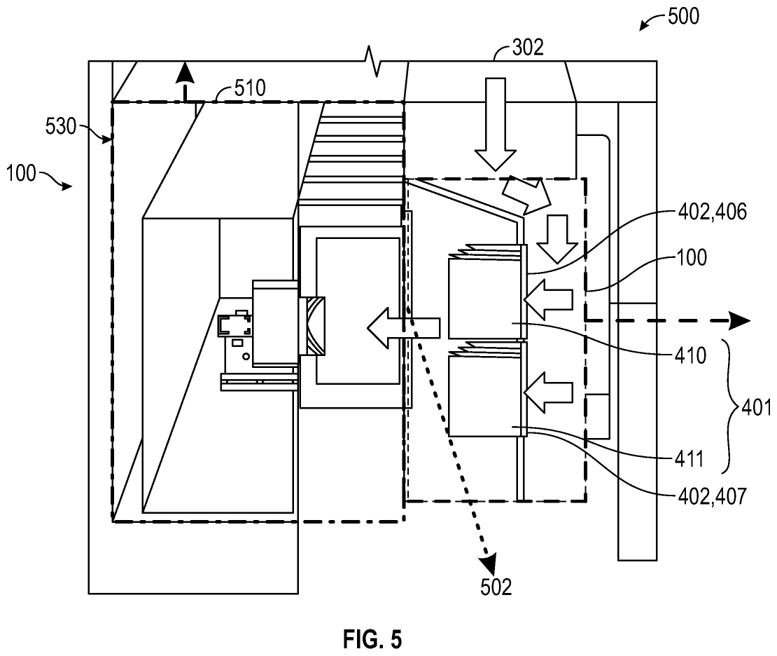

In accordance with an exemplary embodiment, the scrubber box 100 may be used in connection with an existing paint booth. For example, FIG. 5 depicts a portion of a paint booth 530 (including a portion of existing structure or housing 510 thereof) that can be utilized with, coupled with, and/or integrated with the scrubber box 100. In various embodiments, the scrubber box 100 may be utilized with a number of different types of paint booths 530.

With reference back to FIG. 1, in various embodiments, the scrubber box 100 comprises a dry scrubber system that recirculates spray booth air by directing it into scrubber chambers in which filters 120 (including both primary and second filters) capture wet paint particles. In various embodiments, the scrubber box 100 accomplishes these functions with an improved design with a metallic structure and streamlined filtration structure, for example as depicted in the Figures and as described in greater detail further below.

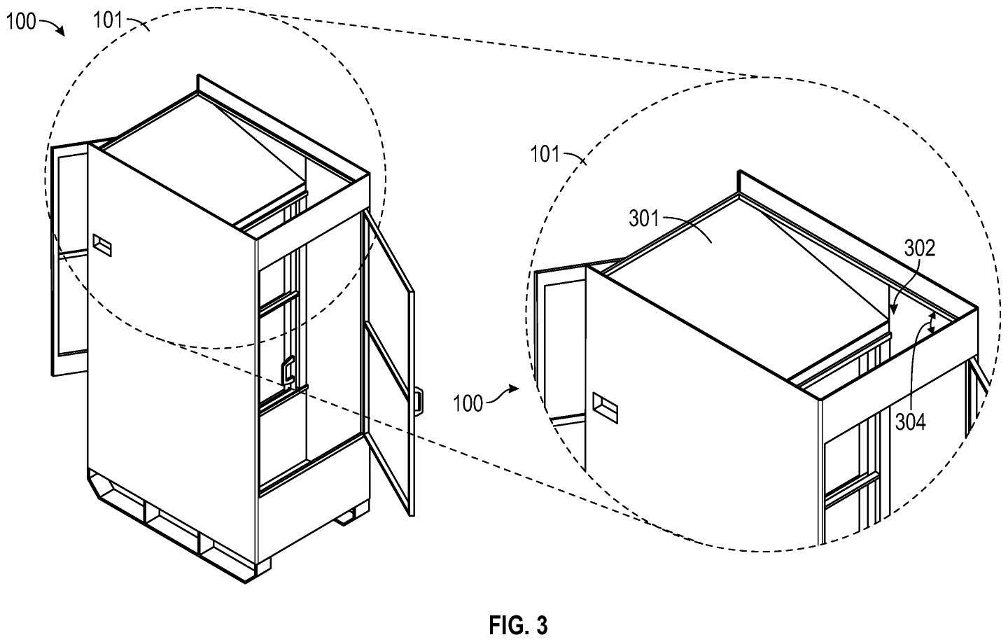

As depicted in FIG. 1, in various embodiments, the scrubber box 100 includes a top portion 101 and a body 102 that are both made of metal. With reference to FIG. 3, in various embodiments, the top portion 101 includes an inclined plate 301 that provides for an inlet 302 with an improved air inlet angle 304 into the scrubber box, in order to provide homogeneously distributed air for the filters 120. In one embodiment, the inlet angle 302 is approximately equal to twenty degrees (20°). However, this may vary in other embodiments.

With reference back to FIGS. 1 and 2, in various embodiments, the body 102 of the scrubber box 100 houses the filters 120. In various embodiments, as depicted in FIGS. 1 and 2, the body 102 comprises, and is at least partially defined by, opposing side walls 104 of the scrubber box 100. Also in various embodiments, the body 102 further comprises, and is also at least partially defined by, a front wall 106 and a rear wall 108 as are also depicted in FIGS. 1 and 2. In various embodiments, the side walls 104, the front wall 106, and the rear wall 108 collectively define the body 100 that serves as a housing for the scrubber box 100, providing support for the scrubber box 100 and storing the filters 120 therein. In various embodiments, multiple stages of filters 120 are housed in respective filter housings 402, which are also described in greater detail further below.

In addition, also as depicted in FIGS. 1 and 2, a front door 107 and a back door frame (also referred to as a rear door frame and/or back door) 109 are also formed into and/or attached to the body 102 of the scrubber box 100. In various embodiments, the front door 107 allows for the different filters 120 (described in greater detail further below) to move therethrough for such filters 120 to be placed into and/or removed out of the scrubber box 100 and/or the body 102 thereof. In various embodiments, the front door 107 also allows for inspection of the filters 120. Also in various embodiments, the back door frame 109 allows for location of a secondary stage of filters (e.g., to place a filter mat), as described in greater detail further below.

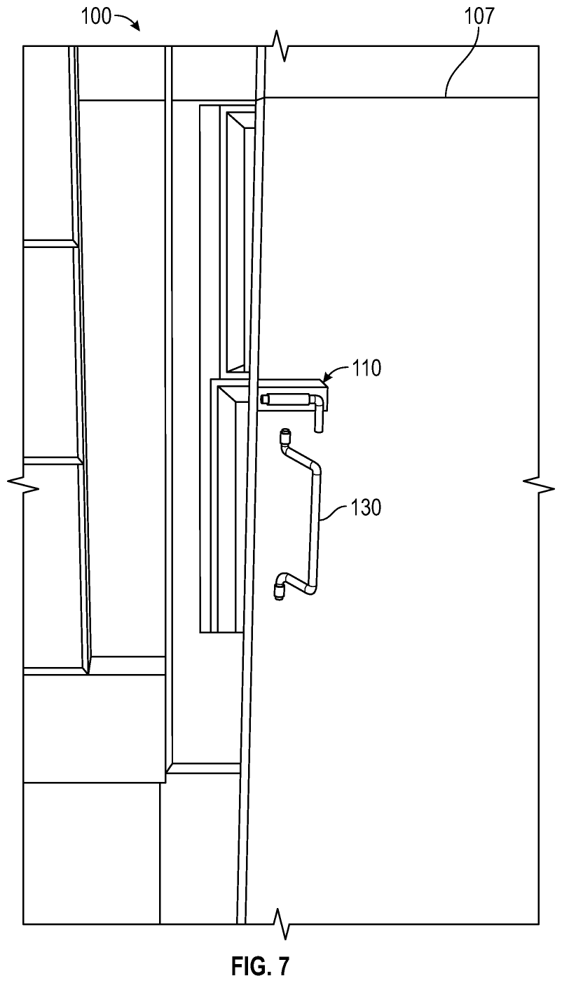

As depicted in FIGS. 1 and 2, in various embodiments the front door 107 includes a handle 120 for opening and closing the front door 107. With reference to FIG. 7, in various embodiments, the front door 107 also includes a locking pin apparatus 710.

With reference back to FIGS. 1 and 2, also in various embodiments, the back door frame 109 includes one or more openings 112, 113 for location of a filters 120, for example for placement of a secondary filter comprising a filter mat, described further below. While two openings 112, 113 are depicted in FIGS. 1 and 2, it will be appreciated that the number of openings 112, 113 may vary in other embodiments.

In addition, as depicted in FIG. 2, in various embodiments a plurality of safety pins 111 are included to facilitate locking and unlocking the back door frame 109. In various embodiments, the safety pins 111 are formed within and/or attached to the rear side of the body 102 (i.e., coplanar with the rear wall 108). While two safety pins 111 are depicted in FIG. 2, it will be appreciated that the number of safety pins 111 may vary in other embodiments.

Also in various embodiments, the scrubber box 100 further includes a drawer 110 as depicted in FIGS. 1 and 2. In various embodiments, the drawer 100 is configured to collect waste from the painting and/or scrubbing processes. Also in various embodiments, the drawer 110 is configured to slide into and out of the body 102 (at least partially) for removal of the collected waste. In various embodiments, the drawer 110 is configured to slide at last partially away from the front side (i.e., coplanar with the front wall 106) and/or the rear side (i.e. coplanar with the rear wall 108) of the body 102 of the scrubber box 100.

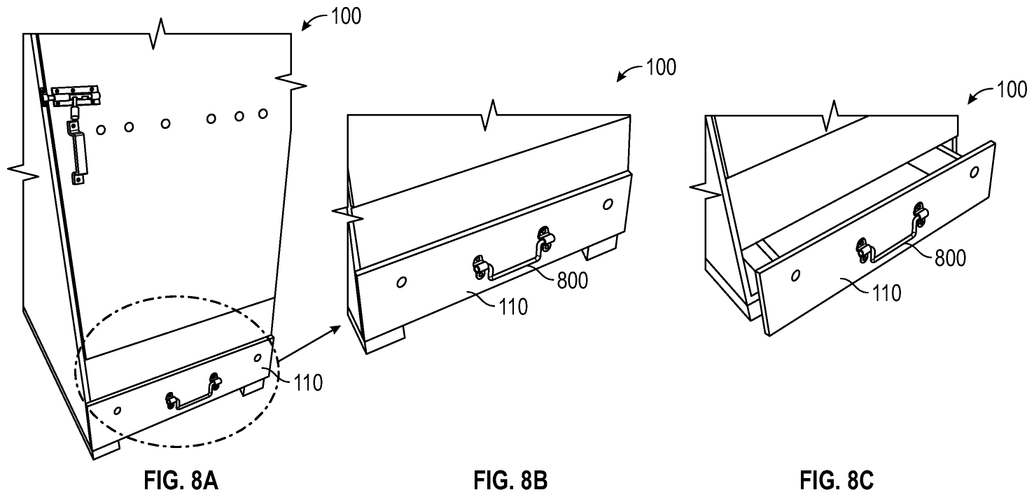

With reference to FIGS. 8A, 8B, and 8C (collectively also referred to herein as “FIG. 8”), the drawer 110 is depicted in both a closed position (as depicted in FIG. 8B) as well as an opened position (as depicted in FIG. 8C), in which the drawer 110 opens from the front side of the scrubber box 100 in accordance with an exemplary embodiment. Also as depicted in FIG. 8, the drawer 110 also includes a handle 800 in an exemplary embodiment.

With reference back to FIGS. 1 and 2, also in various embodiments, the scrubber box 100 includes one or more bottom supports 130. In various embodiments, the bottom supports 130 are formed with and/or attached to a bottom portion of the body 102. Also in various embodiments. The bottom supports 130 are configured to be utilized to move the entire scrubber box 100 with a forklift (not depicted).

In various embodiments, the entire body and housing 102, including the side walls 104, the front wall 106, and the rear wall 108, are each made of metal. In certain embodiments, the entire body/housing 102, including the side walls 104, the front wall 106, and the rear wall 108, are each made of steel. In one such embodiment, the entire body and housing 102, including the side walls 104, the front wall 106, and the rear wall 108, are each made of stainless steel. In another embodiment, the entire body/housing 102, including the side walls 104, the front wall 106, and the rear wall 108, are each made of galvanized steel. In certain embodiments, other components (such as, by way of example, the front door 107, the rear door panel 109, the drawer 110, the safety pins 111, the filters 120, and the bottom supports 130) are also made of steel (e.g. stainless steel and/or galvanized steel).

In addition, in various embodiments, the scrubber box 100 is configured to fit in both current paint booth installations as well as new paint booth installations. In addition, in various embodiments, the scrubber box 100 is configured to be reusable, with its housing 102, and with the filter housing 402, being reusable. In various embodiments, the housing 102 and the filter housing 402 are washable (instead of being replaced each time), thereby reducing waste generation (for example, in comparison with the use of paper and wood with existing technologies). Also in various embodiments, each of the internal and external components, including the top portion 101 (including the inclined plate 301), body 102 (including the side walls 104, front wall 106, and rear wall 108), the front door 107, the rear door panel 109, the safety pins 111, and the bottom supports 130, are welded and sealed together. For example, in certain embodiments, each of the components (other than the body 102) are welded to the body 102. In addition, in various embodiments, the various internal panels and compartments, including the top portion 101 (including the inclined plate 301), body 102 (including the side walls 104, front wall 106, and rear wall 108), the front door 107, the rear door panel 109, the safety pins 111, and the bottom supports 130, are manufactured to be as smooth as possible, for example to decrease any potential coat impregnation.

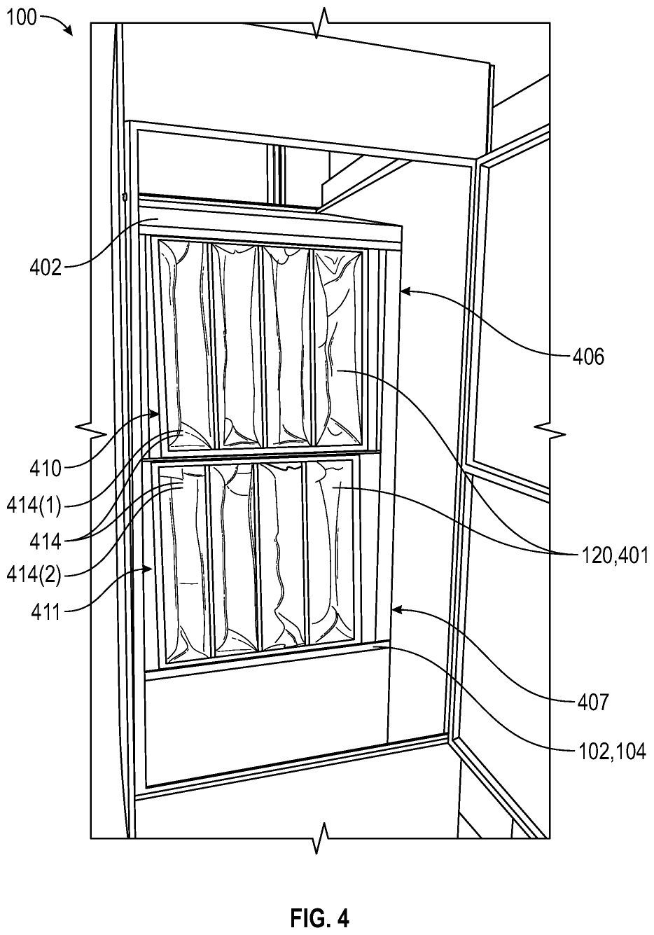

FIG. 4 depicts an interior of the scrubber box 100 of FIG. 1, illustrating certain filters 120 thereof, in accordance with an exemplary embodiment. Specifically, in accordance with an exemplary embodiment, first stage filters 401 are depicted in FIG. 4.

As illustrated in FIG. 4, a filter housing 402 is disposed within the body 102, inside and between the side walls 104, and houses the first stage filters 401. In various embodiments, the filter housing 402 is welded to the side walls 104. Also in various embodiments, the filter housing 402 comprises a metal. In various embodiments, the filter housing 402 comprises the same type of metal as the body 102, such as steel (e.g., in one embodiment stainless steel, and in another embodiment galvanized steel). However, this may vary in other embodiments.

As depicted in FIG. 4, the filter housing 402 forms a first (or upper) frame 406 and a second (or lower) frame 407. In various embodiments, the first (or upper) frame 406 houses a first (or upper) first stage filter 410. Likewise, also in various embodiments, the second (or lower) frame 407 houses a second first stage filter 411, for a total of two (2) first stage filters 410, 411. In various embodiments, each of the first stage filters 410, 411 (also referred to as first stage filters 401) are disposed within a respective slot 414 of the first frame 406 or the second frame 407 of the filter housing 402. In various embodiments, the first filter frame 406 forms one or more slots 414(1) for the upper first stage filter 410, and the second filter frame 407 forms one or more second slots 414(2) for the lower first stage filter 411. Also in various embodiments, each of the slots 414 have standard/commercial filters dimensions, and with the one or more first slots 414 (for the first frame 406) being identical both to one another and to one or more second slots 414 (for the second frame 407).

In various embodiments, each of the first stage filters 401, both in the upper row 410 and the lower row 411, comprises a standard dimension retention filter, each of the same size and shape as one another. In addition, also in various embodiments, each of the first stage filters 401, both the upper first stage filter 410 and the lower first stage filter 411, are of the same model of filter. In various embodiments, each of the first stage filters 401 (i.e., the upper first stage filter 410 and the lower first stage filter 111) comprise standard filters having four (4) pockets with the following dimensions: 593×593×600 mm, for capture specifically of paint particles. Also in various embodiments, each of the standard filters of the first stage filters 401 has a metallic frame to fine in the housing 102 of the scrubber box 100. In certain embodiments, the material of which the first stage filters 401 themselves are made may be variable, for example between different filter suppliers.

In various embodiments, air flows from the inlet 302 of FIG. 3, then through the first stage filters 401 of FIG. 1, and then through second stage filters of FIG. 5. In various embodiments, the second stage filters 502 are assembled between the back door frame 109 and the housing 102 for the scrubber box 100 structure. In various embodiments, the second stage filters 502 capture remaining paint particles that may not have been captured by the first stage filters 401. Also in certain embodiments, the second stage filters 501 are housed in a third filter housing (behind, or to the sear of, the filter housings 402 depicted in FIG. 4). In addition, in certain embodiments, the second stage filters 502 comprise a filter mat 502. In certain embodiments, the filter mat 502 has the following dimensions: 1300×800×50 mm, with progressive density synthetic fibers. The second stage filters 502, and the airflow in general, are depicted in FIG. 5 and are described further below in connection therewith.

FIG. 5 depicts an airflow flow pattern 500 of the scrubber box 100 of FIG. 1, including the implementations of FIGS. 2-4, in accordance with an exemplary embodiment. As depicted in FIG. 5, air flows first through the inlet 302 and toward the first stage filters 401. The air subsequently travels through the first stage filters 401 and toward the second stage filters 502. The air then flows through the second stage filters 502.

Also depicted in FIG. 5 is existing booth structure 510 for a paint booth 530 that is coupled to the scrubber box 100. In various embodiments, the existing booth structure 510 is part of a housing for the paint booth 530. In various embodiments, the scrubber box 100 may be utilized with a number of different types of paint booths 530.

In various embodiments, as depicted in FIG. 5, the air flows first from top to bottom as the air enters the scrubber box 100 via the inlet 302 and flows from the upper first stage filter(s) 401, 410 of the first frame 406 to the lower first stage filter(s) 401, 411 of the second frame 407. Also as depicted in FIG. 5, in various embodiments, the air subsequently flows from front to rear as the air flow from the lower first stage filters 401 of the second frame 407 to the second stage filters 502.

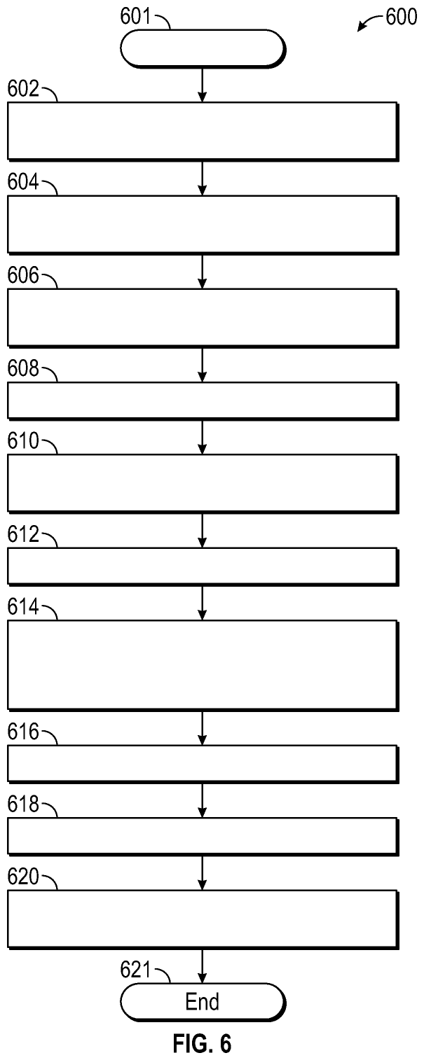

FIG. 6 is a flowchart of a process 600 for preparation for operation of the scrubber box 100, in accordance with an exemplary embodiment. In various embodiments, the process 600 begins at 601, for example when a user desires to prepare the scrubber box 100 for operation.

In various embodiments, safety pins are opened at step 602. In various embodiments, the user opens two safety pins 111 of FIG. 2 disposed near one or more side walls 104 of the scrubber box 100.

Also in various embodiments, a filter mat is located at step 604. In various embodiments, the filter mat 502 of FIG. 5 (i.e., corresponding to the second stage filters) are located at step 604 at the back door frame 109 of FIGS. 1 and 2.

In addition, in various embodiments, at step 606, the filter mat 502 is installed. In various embodiments, edges of the filter mat 502 are permitted to exceed the frame size (and with the frame size being the back door frame 109) in all directions. In certain embodiments, the edges of the filter mat 502 exceed the size of the back door frame 109 by approximately one and one half centimeters (1.5 cm), preferably within a range of once centimeter (1 cm) to two centimeters (2 cm). In certain embodiments, during step 606, the filter mat 502 is located and installed via the front door 107 (if not already installed) and located via the back door frame 109 (e.g., against the back door frame 109).

In various embodiments, the rear door is closed at step 608. Specifically, in various embodiments, the back door frame 109 of FIGS. 1 and 2 are closed at step 608 after the filter mat 502 is installed at step 606.

Also in various embodiments, safety pin are replaced at step 610. Specifically, in various embodiments, the safety pins 111 of FIG. 2 are replaced and locked, in order to secure the back door frame 109 in place and block any movement of the back door frame 109.

Also in various embodiments, the front door is opened at step 612. In various embodiments, the locking pin apparatus 710 of FIG. 7 is opened or unlocked, and then the front door 107 of FIG. 7 is opened via the handle 120 of FIGS. 1 and 7.

In addition, in various embodiments, the first stage filters are installed at step 614. In various embodiments, the first stage filters 401 of FIGS. 4 and 5 are installed at step 614. Also in various embodiments, during step 614, the first stage filters 401 (including the upper and lower first stage filters 401) are installed into their respective upper and lower filter frames 406, 407, one at an upper position, and one at a lower position, during step 614.

Also in an exemplary embodiment, the front door is then closed and locked at step 616. In various embodiments, the front door 107 of FIG. 1 is closed via the handle 120 of FIGS. 1 and 7, and then the locking pin apparatus 710 of FIG. 7 is closed or locked during step 616.

Also in various embodiments, a check is performed at step 618 as to whether the drawer is closed. Specifically, in certain embodiments, the user checks to ensure that the drawer 110 of FIGS. 1 and 8 is in the closed position of FIG. 8B.

In addition, in various embodiments, the scrubber box is moved into position at step 620. Specifically, in certain embodiments, the operator utilizes a forklift, in combination with the bottom supports 130 of FIG. 1, to move the entire scrubber box 100 into its proper position for operation during step 620.

In various embodiments, the process 600 then ends at step 621.

Accordingly, a scrubber box, and an accompanying system and method of preparation for operation, is provided. In various embodiments, the disclosed scrubber box (and accompanying systems and methods of preparation for operation) provide for metallic and reusable filter apparatus, including standard size filters, with a potentially improved inlet angle for air to enter the scrubber box, and for a potentially improved direction of air flow (namely, initially from top to bottom and then subsequently from front to rear), and having inspection capabilities, along with various other features as depicted in the Figure and/or as described above in connection therewith.

It will be appreciated that the scrubber box 100, the various components thereof, along with systems and methods disclosed in combination therewith, may differ from those depicted in FIGS. 1-8 and/or as described above. It will similarly be appreciated that the steps of the process 600 of FIG. 6 may differ, and/or that various steps thereof may be performed simultaneously and/or in a different order, than those depicted in FIG. 6 and/or as described above. It will likewise be appreciated that implementations depicted in the Figures and/or as described above may also vary in different embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A scrubber box for a paint booth, the scrubber box comprising:
a housing;
a plurality of filter frames disposed within the housing; and
a plurality of first stage filters disposed within the housing, the plurality of first stage filters each having the same size and shape as one another.

2. The scrubber box of claim 1, wherein the housing and the plurality of filter frames are each made of metal.

3. The scrubber box of claim 1, wherein the housing and the plurality of filter frames are each reusable.

4. The scrubber box of claim 2, wherein the housing and the plurality of filter frames are welded together.

5. The scrubber box of claim 2, wherein the housing and the plurality of filter frames are each made of steel.

6. The scrubber box of claim 5, wherein the housing and the plurality of filter frames are each made of stainless steel.

7. The scrubber box of claim 5, wherein the housing and the plurality of filter frames are each made of galvanized steel.

8. The scrubber box of claim 1, wherein the plurality of filter frames comprises:
a first filter frame forming one or more first slots for an upper first stage filter; and
a second filter frame disposed below the first filter frame and forming one or more second slots for a lower first stage filter.

9. The scrubber box of claim 8, wherein:
each of the one or more first slots have common filter dimensions; and
each of the one or more second slots also have the common filter dimensions identical to those of the one or more first slots.

10. The scrubber box of claim 8, further comprising:
one or more second stage filters;
wherein the scrubber box is configured to direct airflow:
in a first direction, from top to bottom, from an air inlet through the upper row of first stage filters and the lower row of first stage filters; and
subsequently, in a second direction, from front to rear, through the one or more second stage filters.

11. The scrubber box of claim 10, wherein the one or more second stage filters comprises a mat filter.

12. The scrubber box of claim 1, further comprising:
an inclined top surface on an upper portion of the body, wherein the top surface and the housing form an inlet into the scrubber box.

13. The scrubber box of claim 1, further comprising:
a door with one or more openings for one or more inspection windows for the scrubber box.

14. The scrubber box of claim 1, further comprising:
a drawer configured to collect waste for the scrubber box.

15. The scrubber box of claim 1, further comprising:
one or more bottom supports configured for movement of the scrubber box in conjunction with a forklift.

16. A method of preparing for operation of a scrubber box for a paint booth, the method comprising:
locating a second stage filter via an opened back door frame of the scrubber box;
closing the back door frame;
installing a plurality of first stage filters through an opened front door of the scrubber box; and
closing the front door.

17. The method of claim 16, further comprising:
locking the back door frame and the front door.

18. The method of claim 16, further comprising:
moving the scrubber box into operating position, via a forklift and one or more bottom supports of the scrubber box.

19. A metallic scrubber box for a paint booth, the metallic scrubber box comprising:
a metallic housing;
a plurality of metallic filter frames disposed within the housing, the plurality of metallic filter frames comprising:
a first filter frame forming one or more first slots, each of the one or more first slots having common filter dimensions; and
a second filter frame disposed below the first filter frame and forming one or more second slots, each of the one or more second slots also having the common filter dimensions identical to those of the one or more first slots;
a plurality of first stage filters disposed within the first filter and the second filter, the plurality of first stage filters each having the same size and shape as one another; and
one or more second stage filters disposed behind the second filter frame.

20. The metallic scrubber box of claim 19, wherein the metallic housing and the plurality of metallic filter frames are all welded together.
